(19) United States
(12) Patent Application Publication
(10) Pub. No.: US 2008/0119769 A1
(43) Pub. Date: May 22, 2008

(54) Massage Apparatus

(76) Inventor: Brian Gay, Victoria (AU)

Correspondence Address: Ralph A. Dowell of DOWELL & DOWELL P.C., 2111 Eisenhower Ave, Suite 406, Alexandria, VA, 22314, US

(21) Appl. No.: 10/576,934

(22) PCT Filed: Oct. 25, 2004
(86) PCT No.: PCT/AU04/01470

§ 371 Date: Jul. 9, 2007

(30) Foreign Application Priority Data
Oct. 24, 2003 (AU) 2003905856

(51) Int. Cl. A61H 9/00

(52) U.S. Cl. 601/151

(57) ABSTRACT

The present invention provides an apparatus for treating an extremity of a body, the apparatus including a reservoir (2) adapted to contain a liquid (10), the reservoir wall having a cavity (4) adapted to receive the extremity of the body, wherein the wall of the cavity (8) is at least partially composed of a flexible material. The apparatus can be installed without connection to mains water or sewer, and allows for the saving of substantial volumes of water.

### FIELD

The present invention relates to apparatus and methods for treating the extremities of the body such as the legs, feet, arms, hands, head and neck. The apparatus may be used to massage the feet in a therapeutic context, or as a part of a beauty or relaxation treatment.

### BACKGROUND

The application of massage and heat to the body of humans and animals is well known to have therapeutic and relaxation effects. Heat and massage are known to increase the macro- and microcirculation leading to increased oxygen and nutrient delivery to the tissues, and also the enhanced removal of toxins.

Enhancing circulation can be particularly important in the extremities. Given the distance of the extremities from the heart, and the high resistance provided by the capillary beds, the hands and feet are especially vulnerable to low blood flow. An extreme example of this is seen in persons suffering diabetes where there is a progressive breakdown of the peripheral vasculature, leading to decreased blood flow to the hands and feet.

Treatment of the extremities is also important since these regions are the sites of most musculoskeletal injuries. For example muscle strains and sprains in sports persons often occur in the elbows, knees, hips, shoulders and ankles, as well as the major muscle groups of the limbs. Enhancing circulation to the extremities can also be helpful in a psychological sense, leading to relaxation.

The art has provided a number of devices capable of treating and massaging the extremities. Such devices include hydrotherapy apparatuses which typically consist of a reservoir of warm water, and possibly some method for circulating the water. The pressure of the water on the skin and underlying tissues has a therapeutic and relaxing effect. An example of a hydrotherapy apparatus used to treat the extremities is a foot spa. Such devices are used in both a domestic and commercial environment.

Foot spas have a number of problems however. The most serious problem relates to contamination by micro-organisms such as bacteria and fungi. The skin of the human body contains many micro-organisms which are able to multiply in moist and warm environments such as a foot spa. While the prior art has provided a number of compositions and procedures for decontaminating a foot spa, it cannot be assured that these procedures are carried out properly, if at all. Accordingly, the user of a foot spa can have little confidence in the cleanliness of the apparatus.

Authorities in the United States have warned that mycobacterial infection can lead to persistent dermatological infections on the lower legs of people who use foot spas in nail salons. An outbreak of boils on the lower legs of 110 people who used the same nail salon was reported in the New England Journal of Medicine 2002; 346: 1366-71. In the study, rapidly growing Mycobacterium fortuitum, was isolated from the lesions of 34 affected people. All 10 foot spas used in the salon concerned had large amounts of hair and skin debris behind the suction inlets, from which the mycobacterium was isolated.

All affected persons had soaked their feet for 10 to 15 minutes in a foot spa as part of the pedicure, with the water often reaching mid-calf. People who had shaved with a razor before their pedicure were more than twice as likely to develop boils than those who had not shaved. Up to 37 boils appeared weeks later. They were initially small, erythematous papules, but became large, tender and fluctuant over weeks to months. Some boils progressed to frank ulceration, while others resolved spontaneously but with substantial scarring.

The boils had negative routine bacterial cultures, and failed to respond to routine antibiotics. The boils eventually resolved, over one to 7 months, with anti-mycobacterial antibiotics.

Another contamination problem is that of Tinea paedis, the aetiologic agent in “athlete's foot”. This fungus is highly contagious, thriving in the warm and moist environs of a foot spa. Once contracted, this organism is very difficult to completely eradicate from the feet requiring many weeks of consistent use of an antifungal agent. Even worse, if the nail or nail bed of the toe is infected, complete eradication of the fungus may be impossible.

The foot spas and other hydrotherapy apparatuses of the prior art also generate aerosols as a result of the vigorous circulation of water. The production of aerosols from a body of water containing a pathogenic organism can lead to the airborne distribution of micro-organisms in the environment. These micro-organisms can be inhaled by those in the immediate environs of the foot spa leading to respiratory disease.

Another problem with existing foot spas and other hydrotherapy apparatuses is that the user cannot assume a substantially outstretched position during treatment, and in some models must remain in a substantially upright position. The inability to lie substantially outstretch can lead to discomfort especially where the treatment is for a prolonged period.

A further problem is that apparatus of the prior art leads to the wastage of large amounts of water, as the reservoir must be drained, washed, decontaminated and refilled between users. As an example, a pedicure apparatus of the prior art typically requires between 30 and 40 litres of water to fill the reservoir. Furthermore, it is common practice to fill and drain the reservoir between users for the purpose of cleaning and sanitizing, leading to the use of up to 80 litres of water per user. Each pedicure apparatus may service between 5 and 10 users per day. Thus on a conservative estimate each pedicure apparatus could waste 100,000 litres of water per year, however a figure in excess of 200,000 litres is also possible. When it is considered that many health and beauty salons have more than one pedicure apparatus installed, it may be seen that the problem of water consumption for a single salon can be great.

It is an aspect of the invention to overcome or alleviate a problem of the prior art.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect the present invention provides an apparatus for treating an extremity of a body, the apparatus including a reservoir adapted to contain a liquid, the reservoir wall having a cavity adapted to receive an extremity of the body, wherein the wall of the cavity is at least partially composed of a flexible material. The user is therefore exposed to the hydrodynamic pressure of the surrounding water without actually being directly exposed to the water thereby preventing infection with pathogens present in water. Typically, the apparatus will also include means for circulating water inside the reservoir such as a water jet or air jet. In a particularly preferred form of the invention the flexible material is also resilient, and is capable of transferring heat from the liquid to the lower extremity.

In a preferred form of the invention, the reservoir and cavity forms a closed vessel such that water cannot escape. The closed nature of the vessel allows for very high flow rates and/or pressure from the circulating means without the problem of water spillage. Other advantages are that the apparatus may not require any connection to mains water or sewer for operation and leads to significant savings in water consumption.

In another aspect the present invention provides a method for treating an extremity of a body, the method including the use of an apparatus described herein.

### BRIEF DESCRIPTION OF THE DRAWINGS

FIG. 1A shows a perspective view of a massage apparatus.

FIG. 1B shows a lateral view of the massage device shown in FIG. 1A.

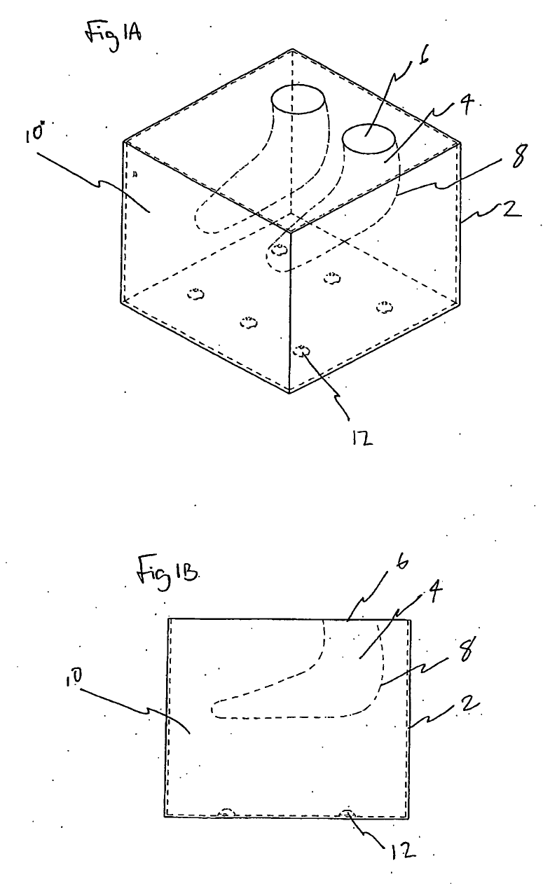

### DETAILED DESCRIPTION OF THE PREFERRED EMBODIMENTS

In a first aspect the present invention provides an apparatus for treating an extremity of a body, the apparatus including a reservoir adapted to contain a liquid, the reservoir wall having a cavity adapted to receive an extremity of the body, wherein the wall of the cavity is at least partially composed of a flexible material.

Referring to the embodiment in the Figure, the reservoir 2 is filled with water that may be heated or cooled to a desired temperature. The user places the extremity into the cavity 4 via the opening 6 for the duration of the treatment, after which it is withdrawn via the opening 6. The flexibility of the cavity wall 8 allows intimate contact with the skin of the extremity by virtue of the hydrodynamic pressure of the surrounding water 10. The user is therefore exposed to the hydrodynamic pressure of the surrounding water without actually being directly exposed to the water. The wall of the cavity may also be composed of a material having the ability to allow transfer of heat from the liquid to the extremity.

It should be understood that while water is a preferred liquid to be used in the reservoir, the use of other liquids are also contemplated. For example, water including one or more solutes (e.g. salt) could be used. Also included is the use of fluids such as mud, gels, semi-gel materials, silicones and the like. The liquid could also include a substantially non-aqueous substance such as sand, powders and the like. The use of different liquids to fill the reservoir may provide differing sensations and therapeutic effects.

Typically, the apparatus will also include means for circulating water inside the reservoir. In a preferred apparatus, the means for circulating water will be the type of jet typically used in spa baths 12. The skilled person will be able to select the appropriate model of jet from a number of those available to the trade. In a preferred form of the invention the jet is a high flow jet or a high pressure jet. While any number of jets may be included the apparatus will typically have about 8 jets. It is the movement and pressure of the circulating water that is generally responsible for providing the massage effect of the apparatus. Accordingly, it is preferred that the jets are directed toward the cavity. Of course, the skilled person will be able to arrange the direction and intensity of the jets to achieve a desired result purely by routine means. In a highly preferred form of the invention the jets are directed toward the cavity from a position lateral to the cavity, and are directed toward the cavity from a position inferior to the cavity. It is even contemplated that the jets could be positioned superior to the cavity, and thereby directed downwards toward the top of the foot.

It should be understood that it is not strictly necessary to incorporate means for circulating water in the apparatus. For example, the reservoir could simply be filled with water (warm, body temperature, or cold) that in itself will provide certain therapeutic effects. It would also be possible to increase or decrease the pressure of the water in the reservoir (where the reservoir is sealed), or alternately increasing and decreasing the pressure.

The apparatus of the present invention may include other means for inducing movement or turbulence in the liquid including the use of ultrasonic transducers, air injection or any other contrivance for inducing a vibration or any pressure change in the liquid.

The present invention provides a number of advantages. A main advantage is that the apparatus does not require the user to come into physical contact with water inside the reservoir, while still being able to be exposed to the warmth of the water and the massaging pressure from any jets inside the reservoir. Since there is no need to immerse the extremity in potentially contaminated water, the use of the apparatus described herein greatly decreases, if not totally prevents infection from any organisms present in the water. The only physical contact made by the user is with the cavity of the reservoir, which can be disinfected more easily than the reservoir.

The provision of a “dry treatment” by the present invention has a further advantage. Many people will avoid a wet treatment simply because of a psychological avoidance of becoming wet, with this being especially the case in a public place such as a shopping centre or airport. Applicant proposes that the apparatus described herein would therefore receive greater custom and therefore return a greater profit per unit for the operator.

Dry treatments as provided for the present apparatus have another advantage in that they do not require high levels of staffing to operate. For example, a single staff member could provide each user with a disposable cavity, with the user fitting the cavity to the apparatus and then commencing the treatment himself simply by activating a “start” button on an electronic console. The treatment could stop automatically, with the user simply disposing of the used cavity without the need for further interaction with a member of staff. There would be no need for a staff member to fill, drain and disinfect the apparatus between users. Furthermore, there would be no need to issue and launder a towel to dry the feet. Indeed, the entire operation could be run without the need for a staff member by coin-operated means.

A further major advantage of the present invention relies on the self contained nature of the apparatus. It will be appreciated that the apparatus could be installed and maintained without the need for any plumbing whatsoever. The apparatus may never need be drained and refilled, and so there is no absolute requirement to locate the apparatus proximal to a mains water supply or a sewer connection. Again, this makes the apparatus particularly suitable for use in areas such as shopping centres, airport lounges, train stations, athletics tracks and the like.

Another advantage of the present invention is that greater pressures and flow rates in terms of water recirculation may be achievable, as compared with an apparatus of the prior art. In a preferred form of the invention, the reservoir and cavity forms a closed vessel such that water cannot escape. The closed nature of the vessel allows for very high flow rates and/or pressure from the circulating means without the problem of water spillage. In some forms of the invention, the pressure may reach over 2 bar, over 3 bar, and more preferably over 4 bar. These very high pressures increase the hydrodynamic pressure on an extremity placed inside the cavity of the apparatus, providing a superior massage.

Another significant advantage is that the present invention has the potential to save large volumes of water. Water is clearly a limited and precious resource in many countries, and hydrotherapy apparatuses (and especially commercial foot spa apparatuses) consume vast amounts of water. As will be appreciated, given the inevitable contamination of water in contrivances of the prior art they must be emptied and refilled after every use to maintain cleanliness. In light of the contamination, they must also be vigorously cleaned and disinfected at regular intervals. Given that the apparatus of the present invention allows water to be re-used many times before changing, substantial savings in water consumption are achieved. Indeed, if the appropriate biocides are included in the first fill of the apparatus the water may never be changed over the life of the apparatus. It is possible however that the water level may need to be supplemented from time to time due to normal evaporation through the wall of the cavity, however the volume used would be insignificant. It is contemplated that use of a hydrotherapy apparatus described herein may save as much of 90% of water routinely consumed by apparatuses of the prior art.

Given that the apparatus of the present invention uses very limited volumes of water, it is now possible to increase the size of the reservoir without the concern for wasting large amounts of water. It is now also possible for users to have treatments on a more frequent basis given the very low volume of water used by these apparatuses. Many users and operators are concerned with saving water predominantly because of a belief that the environment should be protected and natural resources must therefore be managed in a sustainable manner.

The cavity may be integral with the pedicure apparatus or alternatively it may be disposable. The cavity may be a multiwalled structure capable of receiving a liquid or gas between the walls, or jacket, so as to apply sufficient pressure about the lower extremity placed within the cavity. This allows massaging of the lower extremity by the hydrostatic pressure from the liquid in the jacket. Where the vessel of the present pedicure apparatus holds an amount of liquid, the hydrostatic pressure applied by the liquid in the jacket is capable of contributing to the massaging effect to the lower extremity. However, it can be appreciated that the hydrostatic pressure applied to the lower extremity by the liquid in the jacket is also capable of contributing to the massaging effect in the absence of liquid within the vessel. The liquid introduced into the jacket of the cavity may be the same or different to the liquid within the vessel.

The cavity may be adapted to prevent collapse due to external liquid pressure. This may be achieved by providing a cavity having a multiwalled structure in which liquid or gas can be introduced between the walls to hold the cavity open to receive the extremity, the liquid or gas being removed once the extremity is in position to allow massaging of the lower extremity by hydrostatic pressure from the liquid in the vessel.

As mentioned previously, it is preferred that the flexible material has sufficient heat transfer properties so that the lower extremity of the user may be warmed or cooled as necessary by the liquid in the reservoir. However, heat transfer to the extremity can be achieved by other means. For example, where the cavity is a multiwalled structure, the temperature of the liquid in the jacket may be altered by varying the temperature of the liquid entering and/or exiting the jacket. The movement of the liquid may be facilitated by a pump or by mains plumbing pressure (e.g. where the liquid is water). Typically, the alternating temperature of the liquid in the jacket (e.g. between hot and cold) provides a pleasurable sensation to the user. It is generally considered that the more rapid the variation in temperature of the liquid in the jacket, the more pleasurable the sensation experienced by the user. Thus, the apparatus of the present invention has the advantage of allowing the user to apply pressure and heat to the lower extremity for an infinite period of time.

In one form of the invention the apparatus includes a disposable cavity wall. Alternatively, the cavity wall may be permanent, and the user could place a covering over the extremity before placing it into the cavity. The covering could be water-tight or absorbent. After use, the covering is disposed of leaving the surface of the cavity untouched. This will be of greatest advantage in the commercial use of foot spas that are used by many people and the risk of cross contamination greatest.

Another advantage is that substantially no aerosols are generated given the closed nature of the reservoir. It is known that aerosols can carry very serious pathogens in the air. The most infamous example is that of Legionella species (the aetiologic agent of Legionnaires' disease) which are spread by aerosols generated in air conditioning cooling towers. The closed nature of the apparatus of the present invention prevents establishment of an air/water interface, and therefore the generation of aerosols.

Another advantage afforded by the cavity is that it provides a liquid-proof barrier between the user and the liquid. This more easily allows for the provision of treatments in public places such as airports, shopping centres and the like. People are often embarrassed to remove their socks in public places due to problems of foot odour and unsightly conditions such as corns, bunions, and ingrown toe nails. Since the feet are never exposed to the liquid in this form of the invention, it is possible that the socks may be left on. Even if the person could be persuaded to remove their socks, there is the inconvenience of having to dry the feet after treatment.

A further advantage of the invention is that the reservoir can be inclined at any angle without spillage of water. Existing foot spas must remain substantially horizontal, therefore requiring the user to sit upright, or to at least have the legs significantly bent at the knee. The apparatus of the present invention provides a foot spa that may be inclined at any angle, thereby allowing the user to recline at a more comfortable position during treatment, and even in a position where the legs are essentially extended with little or no bending at the knee. The ability to lie outstretched during a treatment adds to the pleasurable sensation of the foot spa, and allows a user to experience a treatment when reclining on an airplane, for example. Sports injuries can require treatments of many hours duration, often extending into sleep periods. Use of the apparatus of the present invention will allow an athlete to sleep in a horizontal position while still undergoing treatment.

Indeed, where the apparatus is completely sealed it is now possible for the first time to administer hydrotherapy with the feet raised above the plane of the reclining body, and even to the point where the feet are higher than the heart. In this position, the drainage of excess fluid and toxins are more easily drained from the tissue beds of the feet and legs. The drainage could be further facilitated by the pressure and/or temperature exerted by the water in the apparatus which could effectively squeeze extracellular fluid and lymph from the tissue.

The flexible material may be any material that allows the user to feel the hydrodynamic pressure of the surrounding water. It is further preferred that the flexible material has sufficient heat transfer properties so that the extremity of the user may be warmed or cooled as necessary.

The flexible material may be a sheet-like plastic such as polyvinyl chloride or a low density polyethylene. The flexible material could even be a woven material such as sailcloth.

In a particularly preferred form of the invention the flexible material is also resilient. Examples of flexible and resilient materials useful in the present invention include any natural or synthetic rubber including but not limited to nitrile rubber, silicone rubber, fluoro-silicone rubber, butyl rubber, polybutadine rubber, neoprene rubber, hypalon, EPDM, viton, polyurethane, and latex.

The flexible material may also be a composite of any of the materials disclosed herein.

The cavity may be integral with the reservoir, or it could be fabricated separately and subsequently joined to the reservoir. The joining may be achieved by an adhesive, heat sealing, crimping or any other method able to provide a substantially water tight seal.

It will be appreciated that it is only necessary for a portion of the walls of the cavity to be composed of a flexible material, though preferably the entire cavity wall is composed of a flexible material.

Where the cavity is not integral with the reservoir, it may be attached in such a way as to be replaceable. Accordingly, the present invention also includes a replacement cavity alone that may be sold as a consumable item. It will also be understood that existing foot spas may be retrofitted with a cavity as described herein. Accordingly, the present invention includes a cavity composed of a flexible material adapted to be attached to an existing foot spa. It will also be understood that existing apparatuses may be retrofitted with a cavity as described herein. A kit for retrofitting may further include an item selected from the group consisting of a pump, a heater, a heat exchanger, a filter, and a jet. The kit may further include any necessary plumbing pipework required to retrofit a hydrotherapy apparatus.

Typically, the walls of the reservoir not concerned with receiving an extremity are substantially inflexible, and may be composed of a material such as fibreglass or a rigid plastic, metal, glass or wood.

The cavity may be any shape capable of receiving an extremity. In one form of the invention the cavity is generally cylindrical. A cavity of this type will be useful for receiving an arm or a leg. It is contemplated that more than one extremity may be treated. For example, the cavity may be shaped like a pair of trousers where the user inserts both legs, and even the pelvis into the cavity.

In another form of the invention the cavity is quite short, for example where a hand or foot is to be treated. For the treatment of a foot, the cavity may be substantially sock-shaped. For the treatment of a foot and calf, the cavity may be substantially boot-shaped. For the treatment of a hand, the cavity may be substantially glove-shaped or mitten-shaped. For the treatment of an arm and hand, the cavity may have the shape of an elongated glove or mitten.

The apparatus may also be used to treat the head and neck. In this case the cavity may be shaped to comfortably receive the back of the head and neck. The apparatus could also be used for facial massage where the cavity would be shaped to comfortably receive projections from the face such as the nose, cheeks and chin.

Preferably, the cavity is shaped such that it is able to at least partially turn inside out upon activation of a water jet or air jet in the apparatus. The force of air and/or water applied to the cavity causes it to invert, thereby extending outwards and away from the reservoir. This allows for more easy cleaning of the cavity, and in some circumstances may facilitate the entry of an extremity into the cavity.

The apparatus of the present invention may include means for heating or cooling the liquid contained in the vessel. A heat exchanger can be used to counteract heating of the water due to passage through the pump.

The apparatus may further include covers that at least partially occlude the opening of the cavity. The cover may act to prevent the entry of foreign objects or contaminating organisms into the cavity, or to limit heat loss or water evaporation across the cavity wall. Also included may be means for washing the user before or after treatment. The means for washing may include a hand shower, and means for controlling water sloughing from the user.

It is contemplated that the reservoir of the apparatus may be connected to one or more secondary reservoirs, each secondary reservoir having means for transferring the contents of the secondary reservoir to or from the reservoir. The tanks may be used simply to store water, to pre-heat water or pre-cool water. It is also contemplated that the tanks could be used to achieve a rapid change in temperature water contained in the reservoir. For example, if in the first instance the reservoir contained warm water, the temperature of the water could be rapidly changed by draining the warm water and admitting cooler water stored in a secondary reservoir. As a further preferred embodiment of the invention the apparatus is connected to two secondary reservoirs, this allowing rapid oscillation of water temperature in the reservoir. In use, water having a first temperature in the reservoir is drained into a first secondary reservoir, followed by the admission of water having a second temperature from a second secondary reservoir. The water having the second temperature is then drained into the second secondary reservoir and water having the first temperature re-admitted into the reservoir. This cycle may be repeated as often as desired to produce rapid temperature cycling in the reservoir.

The use of a secondary reservoir may also facilitate the admission and or removal of the extremity where the apparatus. Due to hydrostatic pressure on the walls of the cavity, some users may experience difficulty in inserting or removing a lower extremity into the cavity when the vessel is full of water. Difficulty in inserting a lower extremity could be especially difficult where the liquid is very viscous (such as mud) or where it is granular or powder-like (such as sand). This problem could be overcome by removing the liquid and storing it in a separate tank while the extremity is inserted or removed.

In another aspect the present invention provides a method for treating an extremity of a body, the method including the use of an apparatus described herein.

The method may include further features such as the use of any skin care substance such as moisturizer, scented oil, seaweed products, mud, salts and the like which are placed directly on the extremity or in the cavity. Given that the water in the reservoir may be warm, this will assist the skin care substance or medicament to penetrate the skin to leave the feet fragrant and supple.

The method may also include the use of medicaments in a similar manner to that described above. It is contemplated that the absorption of pharmaceutically active substances will be enhanced by the massage and/or heat supplied by the apparatus. Medicaments that may be used in combination with the methods of the present invention include antibacterials, antifungals, antivirals and the like. Such methods will be very helpful for diabetics for example who suffer from degeneration of the extremities due to vascular necrotization, leading to subsequent infection.

It is known that treatment of the diabetic foot responds well to treatment with carbon dioxide gas. This treatment modality could be included in the apparatus and methods described herein by pumping the gas into the cavity during treatment. The cavity could include a cuff such that the extremity is essentially sealed thereby allowing gas to be maintained in high concentrations.

It is anticipated that the present invention will find use in the treatment of humans. However, it is also contemplated that the present invention will be useful in the treatment of animals, as they are similarly afflicted with conditions of the extremities. The invention will be particularly useful in the treatment of race horses and greyhounds, and other animals prone to musculoskeletal injuries.

Finally, it is to be understood that various other modifications and/or alterations may be made without departing from the spirit of the present invention as outlined herein.

1. An apparatus for treating an extremity of a body, the apparatus including a reservoir adapted to contain a liquid, the reservoir wall having a cavity adapted to receive the extremity of the body, wherein the wall of the cavity is at least partially composed of a flexible material.

2. An apparatus according to claim 1 wherein the flexible material is capable of transferring pressure or heat from the liquid to the extremity.

3. An apparatus according to claim 1 wherein the flexible material is substantially impermeable to the liquid.

4. An apparatus according to claim 3 wherein the flexible material is a sheet-like plastic.

5. An apparatus according to claim 4 wherein the sheet-like plastic is polyvinyl chloride or low density polyethylene.

6. An apparatus according to claim 3 wherein the flexible material is sailcloth.

7. An apparatus according to claim 3 wherein the flexible material is resilient.

8. An apparatus according to claim 1 wherein the flexible material is a natural or synthetic rubber.

9. An apparatus according to claim 8 wherein the flexible material is selected from the group consisting nitrile rubber, silicone rubber, fluorosilicone rubber, butyl rubber, polybutadine rubber, neoprene rubber, hypalon, EPDM, viton, polyurethane, and latex.

10. An apparatus according to claim 1 wherein the entire cavity is composed of a flexible material.

11. An apparatus according to claim 1 wherein the cavity is generally cylindrical.

12. An apparatus according to claim 1 wherein the cavity is substantially sock-shaped.

13. An apparatus according to claim 1 wherein the cavity is substantially boot-shaped.

14. An apparatus according to claim 1 wherein the cavity is substantially glove-shaped or mitten-shaped.

15. An apparatus according to claim 1 wherein the cavity has the shape of an elongated glove or mitten.

16. An apparatus according to claim 1 wherein the cavity has the shape of a pair of trousers.

17. An apparatus according to claim 1 wherein the reservoir and cavity forms a sealed vessel such that the liquid is not capable of escape.

18. An apparatus according to claim 1 including at least one jet capable of propelling the liquid within the vessel.

19. An apparatus according to claim 18 wherein the at least one jet is capable of propelling the liquid at a pressure of at least 2 bar.

20. An apparatus according to claim 18 wherein the at least one jet is capable of propelling the liquid at a pressure of at least 3 bar.

21. An apparatus according to claim 18 wherein the at least one jet is capable of propelling the liquid at a pressure of at least 4 bar.

22. An apparatus according to claim 1 including at least one secondary reservoir, wherein the reservoir and the at least one secondary reservoir are connected such that the liquid can be interchanged between the reservoir and the at least one secondary reservoir.

23. An apparatus according to claim 1 devoid of means for connecting to mains water and/or sewer.

24. A cavity adapted to replace a cavity included in an apparatus according to claim 1.

25. A cavity adapted for use in retrofitting a hydrotherapy apparatus, the retrofitting being capable of producing an apparatus according to claim 1.

26. A method for treating an extremity of a body, the method including the use of an apparatus according to claim 1.

27. A method according to claim 26 including placing a skin care substance or medicament into the cavity or directly onto the extremity.

28. A method according to claim 27 wherein at least a portion of the extremity of the body is higher than the heart.
